(19) United States
(12) Patent Application Publication
(10) Pub. No.: US 2014/0091741 A1
(43) Pub. Date: Apr. 3, 2014

(54) MOTOR DRIVING APPARATUS AND MOTOR DRIVING METHOD

(71) Applicant: SAMSUNG ELECTRO-MECHANICS CO., LTD., Suwon (KR)

(72) Inventor: Joo Yul KO, Suwon (KR)

(73) Assignee: SAMSUNG ELECTRO-MECHANICS CO., LTD., Suwon (KR)

(21) Appl. No.: 13/735,472

(22) Filed: Jan. 7, 2013

(30) Foreign Application Priority Data
Sep. 28, 2012 (KR) 10-2012-0109305

(51) Int. Cl. H02P 6/08

(52) U.S. Cl. CPC H02P 6/08
USPC 318/400.13

(57) ABSTRACT

There are provided a motor driving apparatus and a motor driving method capable of decreasing power consumption by readjusting a preset duty ratio according to a voltage level of driving power. The motor driving apparatus includes: a driving power detecting unit detecting a voltage level of driving power used to drive a motor; a speed controlling unit adjusting a preset duty ratio of a pulse width modulation (PWM) signal when the voltage level detected by the driving power detecting unit is equal to or less than a preset reference voltage; a driving controlling unit generating a driving signal having the duty ratio from the speed controlling unit; and a driving unit driving the motor according to the driving signal of the driving controlling unit.

### CROSS-REFERENCE TO RELATED APPLICATIONS

This application claims the priority of Korean Patent Application No. 10-2012-0109305 filed on Sep. 28, 2012, in the Korean Intellectual Property Office, the disclosure of which is incorporated herein by reference.

### BACKGROUND OF THE INVENTION

1. Field of the Invention

The present invention relates to a motor driving apparatus and a motor driving method capable of decreasing consumption of driving power used to drive a motor.

2. Description of the Related Art

Recently, due to demand for electrical and electronic devices for personal, domestic, commercial and industrial use, the use of electrical and electronic devices has rapidly increased.

Interior spaces of these devices may be provided with a driving circuit provided in order to drive a specific operation. An example of an electrical or electronic device may include a motor.

A brushless direct current (BLDC) motor generally means a DC motor able to conduct a current or adjust a current direction using a non-contact position detector and a semiconductor element rather than using a mechanical contact unit such as a brush, a commutator, or the like, in a DC motor.

In order to drive the BLDC motor, a driving apparatus may be used.

FIG. 1 is a configuration diagram of a general motor driving apparatus.

Referring to FIG. 1, a general motor driving apparatus 10 may include a controlling unit 11 and a driving unit 12.

The controlling unit 11 may control driving of a motor, and the driving unit 12 may turn four field effect transistors (FETs) on or off according to driving signals (POUT1, POUT2, NOUT1, and NOUT2) of the controlling unit 11 to drive the motor and may be supplied with driving power VDD required for driving the motor, as shown in FIG. 1.

FIG. 2 is a diagram showing driving signals of the motor driving apparatus.

Referring to FIGS. 1 and 2, the driving signals transferred from the controlling unit 11 to the driving unit 12 may be divided into four kinds thereof, and be transferred in a sequence of reference numerals I, II, III, and IV.

That is, a first PMOS FET P1 and a second NMOS FET N2 may be turned on by the driving signal denoted by reference numeral I, and the first PMOS FET P1 and the second NMOS FET N2 may be turned off and a second PMOS FET P2 and a first NMOS FET N1 may be turned on by the driving signal denoted by reference numeral II.

Again, the second PMOS FET P2 and the first NMOS FET N1 may be turned off and the first PMOS FET P1 and the second NMOS FET N2 may be turned on by the driving signal denoted by reference numeral III, and the first PMOS FET P1 and the second NMOS FET N2 may be turned off and the second PMOS FET P2 and the first NMOS FET N1 may be turned on by the driving signal denoted by reference numeral IV.

In this driving scheme, when the first PMOS FET P1 and the second PMOS FET P2 are turned on, pulse width modulation (PWM) signals (oblique line portions of FIG. 2) are generated, whereby a speed of the motor may be adjusted.

That is, as described above, the PWM signal is used to drive the motor. In this case, since the speed of the motor may be adjusted according to an on-duty of the PWM signal, a duty of the PWM signal may be detected in order to precisely adjust the speed of the motor as in the related art.

Here, in the case in which a battery is used, when a predetermined time has elapsed, a voltage drop may occur in the driving power VDD. Therefore, the speed of the motor may be decreased.

In the case of increasing the on-duty of the PWM signal in order to re-increase the decreased speed, the voltage drop in the driving power VDD is further increased, such that a defect in managing the power may occur.

### Related Art Document

(Patent Document 1) Korean Patent Laid-open Publication No.10-1998-0081113

### SUMMARY OF THE INVENTION

An aspect of the present invention provides a motor driving apparatus and a motor driving method, capable of decreasing power consumption by readjusting a preset duty ratio according to a voltage level of driving power.

According to an aspect of the present invention, there is provided a motor driving apparatus including: a driving power detecting unit detecting a voltage level of driving power used to drive a motor; a speed controlling unit adjusting a preset duty ratio of a pulse width modulation (PWM) signal when the voltage level detected by the driving power detecting unit is equal to or less than a preset reference voltage; a driving controlling unit generating a driving signal having the duty ratio from the speed controlling unit; and a driving unit driving the motor according to the driving signal of the driving controlling unit.

The speed controlling unit may adjust a preset on-duty ratio of the PWM signal.

The speed controlling unit may decrease the preset on-duty ratio of the PWM signal when the voltage level detected by the driving power detecting unit is equal to or less than that of the reference voltage.

The motor driving apparatus may further include a memory storing the duty ratio corresponding to the PWM signal provided from the outside therein.

The motor driving apparatus may further include a speed detecting unit detecting a speed of the motor.

The driving power detecting unit may include a comparator comparing the detected voltage level of the driving power and the voltage level of the reference voltage.

The comparator may perform a hysteresis operation.

The reference voltage may include a first reference voltage having a preset voltage level and a second reference voltage having a voltage level set to be higher than the voltage level of the first reference voltage.

According to another aspect of the present invention, there is provided a motor driving method including: detecting a voltage level of driving power used to drive a motor; comparing the detected voltage level of the driving power and a voltage level of a preset reference voltage; adjusting a preset duty ratio of a PWM signal when the detected voltage level of the driving power is equal to or less than that of the reference voltage according to a comparison result; and driving the motor according to a driving signal having the adjusted duty ratio.

In the adjusting of the preset duty ratio, a preset on-duty ratio of the PWM signal may be adjusted.

In the adjusting of the preset duty ratio, the preset on-duty ratio of the PWM signal may be decreased when the detected voltage level of the driving power is equal to or less than that of the reference voltage according to the comparison result.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a configuration diagram of a general motor driving apparatus;

FIG. 2 is a diagram showing driving signals of the motor driving apparatus;

FIG. 3 is a schematic configuration diagram of a motor driving apparatus according to an embodiment of the present invention;

FIG. 4 is a schematic configuration diagram of a driving power detecting unit used in the motor driving apparatus according to the embodiment of the present invention; and

FIG. 5 is a flow chart of a motor driving method according to an embodiment of the present invention.

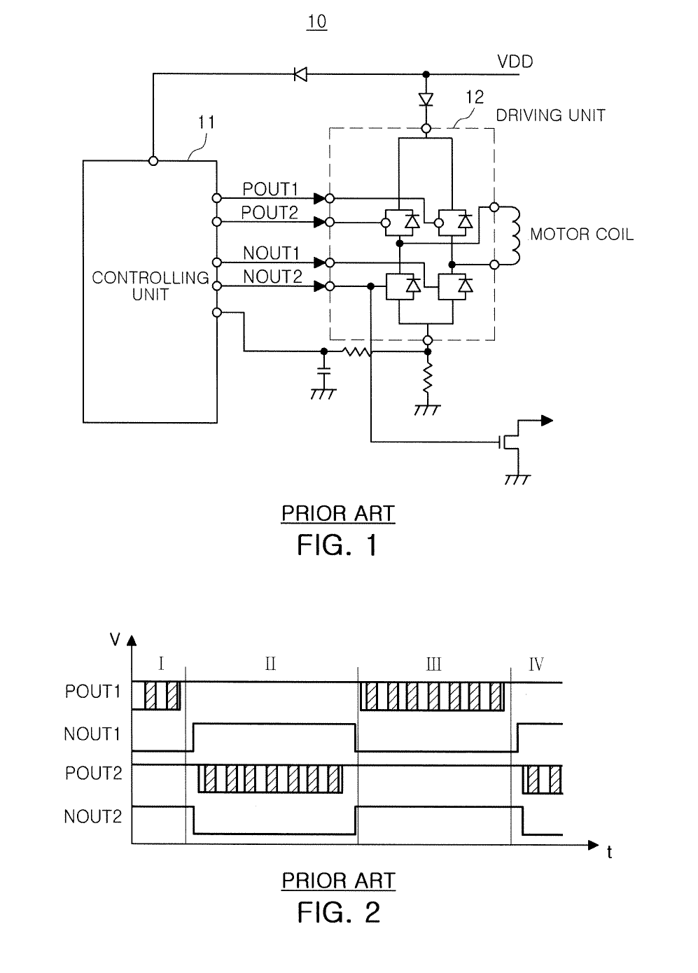

### DETAILED DESCRIPTION OF THE EMBODIMENTS

Hereinafter, embodiments of the present invention will be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the shapes and dimensions of elements may be exaggerated for clarity, and the same reference numerals will be used throughout to designate the same or like elements.

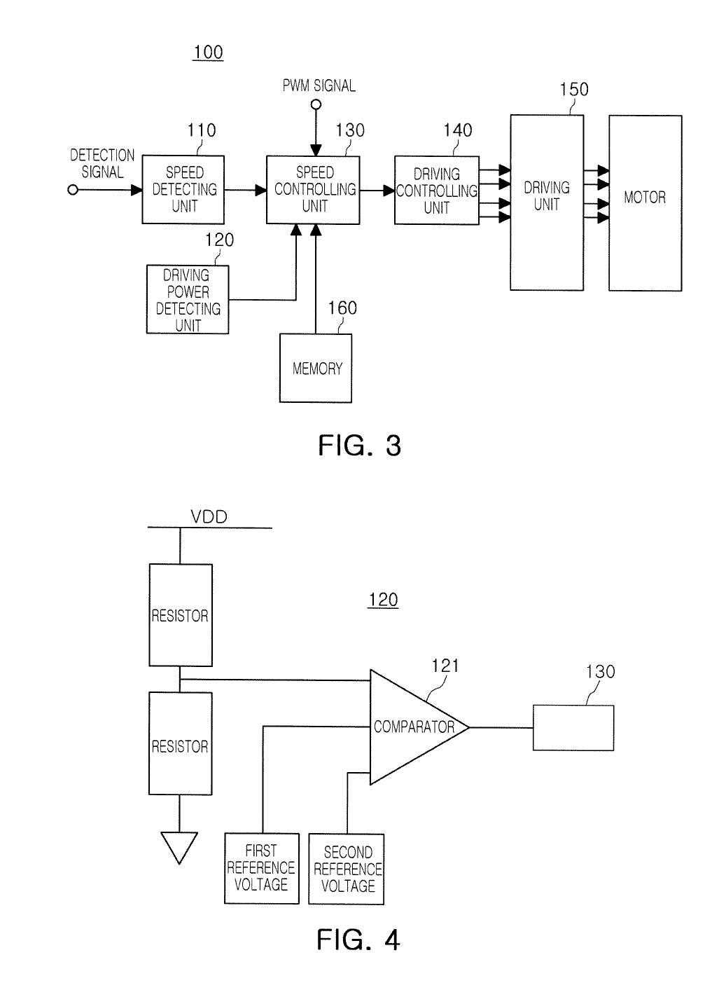

FIG. 3 is a schematic configuration diagram of a motor driving apparatus according to an embodiment of the present invention.

Referring to FIG. 3, a motor driving apparatus 100 according to the embodiment of the present invention may include a speed detecting unit 110, a driving power detecting unit 120, a speed controlling unit 130, a driving controlling unit 140, a driving unit 150, and a memory 160.

The speed detecting unit 110 may detect a speed of a motor. To this end, the speed detecting unit 110 may receive a hall signal or a counter electromotive force signal having information regarding a position and rotation of the motor.

The driving power detecting unit 120 may detect a voltage level of driving power used to drive the motor.

The driving power detecting unit 120 may compare the detected voltage level of the driving power with a reference voltage having a preset voltage level and transfer the comparison result to the speed controlling unit 130.

The speed controlling unit 130 may determine whether or not the detected speed is a target speed, based on a pulse width modulation (PWM) signal input from the outside to control the speed of the motor.

The speed controlling unit 130 may receive a corresponding duty ratio from the memory 160 based on speed information included in the PWM signal to control the speed of the motor. Here, the duty ratio may be an on-duty ratio.

Meanwhile, the driving power used to drive the motor may be provided from a battery. Therefore, when the motor is driven for a predetermined time, the voltage level of the driving power may be decreased.

For example, a voltage level of driving power may be decreased, for example, from 12V to 5V or less, after a predetermined time has elapses.

Therefore, the speed controlling unit 130 may readjust a set on-duty ratio based on the comparison result of the driving power detecting unit 120.

That is, even in the case that an on-duty ratio of the input PWM signal is 100%, when driving power of 5V or less is supplied thereto, the speed controlling unit 130 may readjust the on-duty ratio to be 50% and transfer the readjusted on-duty ratio to the driving controlling unit 140.

The driving controlling unit 140 may provide a driving controlling signal controlling the driving of the motor based on the PWM signal from the speed controlling unit 130.

The driving unit 150 may drive the motor according to the driving controlling signal from the driving controlling unit 140.

The memory 160 may store on-duty ratio information corresponding to the speed information of the input PWM signal therein as described above and provide the stored on-duty ratio on the request of the speed controlling unit 130.

FIG. 4 is a schematic configuration diagram of a driving power detecting unit used in the motor driving apparatus according to the embodiment of the present invention.

Referring to FIGS. 3 and 4, the driving power detecting unit 120 used in the motor driving apparatus 100 according to the embodiment of the present invention may include a comparator 121 and a plurality of detecting resistors.

The plurality of detecting resistors may divide the voltage level of the driving power VDD according to a preset resistance ratio and transfer the divided voltage levels to the comparator 121.

The comparator 121 may compare a reference voltage having a preset voltage level and the detected voltage level of the driving power and perform a hysteresis operation in the comparison.

That is, the reference voltage may include a first reference voltage having a preset voltage level and a second reference voltage having a voltage level set to be higher than that of the first reference voltage, and the first reference voltage may be used to determine whether the voltage level of the driving power is decreased to a set level or less.

On the other hand, the decreased voltage level of the driving power may be increased due to charging or replacement of the battery, a change in a power supplying scheme, or the like.

Therefore, the second reference voltage maybe used in the case in which a normal operation is requested such that the

PWM signal of the speed controlling unit 130 has the on-duty ratio applied as being set when the voltage level of the driving power is increased.

For example, when driving power of 12V is decreased to the voltage level of the first reference voltage, that is, 5V or less, since the voltage level of the driving power is a set level or less, the speed controlling unit 130 maybe requested to perform a power managing operation by the driving power detecting unit 120.

On the other hand, when the voltage level of driving power decreased to 5V or less is increased to the voltage level of the second reference voltage, that is, 6V or more, since the driving power is within a normal power range, the speed controlling unit 130 may be requested to perform a normal operation by the driving power detecting unit 120.

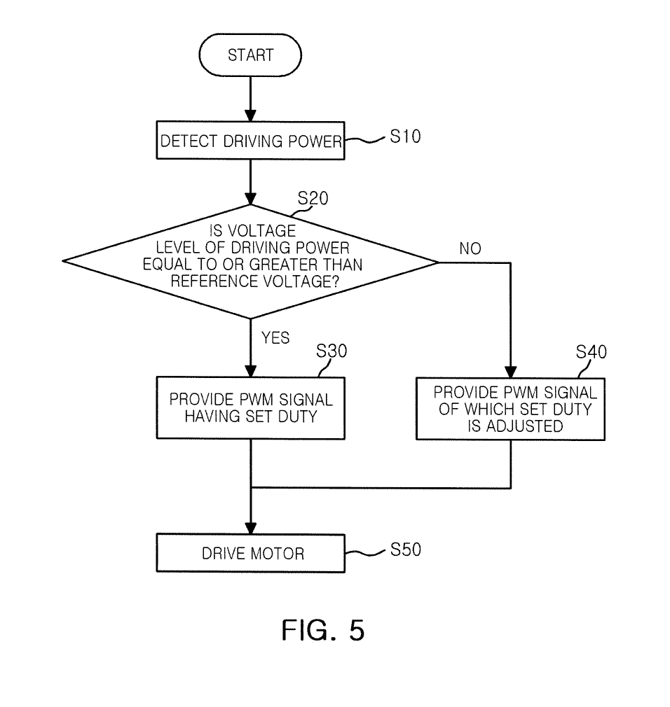

FIG. 5 is a flow chart of a motor driving method according to an embodiment of the present invention.

Referring to FIGS. 3 through 5, in the motor driving method according to the embodiment of the present invention, the driving power detecting unit 120 may first detect the voltage level of the driving power used to drive the motor (S10).

Then, the driving power detecting unit 120 may compare the detected voltage level of the driving power with the voltage level of the reference voltage and transfer the comparison result to the speed controlling unit 130 (S20).

The speed controlling unit 130 may readjust the set on-duty ratio of the PWM signal according to the comparison result of the driving power detecting unit 120 and request that the driving controlling unit 140 controls the driving of the motor at a corresponding speed.

That is, in the case in which the detected voltage level of the driving power is equal to or less than the preset level, the speed controlling unit 130 may adjust and decrease the on-duty ratio of the input PWM signal and request that the driving controlling unit 140 controls the driving of the motor according to the adjusted on-duty ratio (S40).

On the other hand, in the case in which the detected voltage level of the driving power is the set level or more, the speed controlling unit 130 may request that the driving controlling unit 140 controls the driving of the motor according to the on-duty ratio of the input PWM signal (S30).

The driving controlling unit 140 may provide the driving controlling signal to the driving unit 150 according to the request of the speed controlling unit 130, and the driving unit 150 may drive the motor accordingly (S50).

As set forth above, according to the embodiment of the present invention, the preset duty ratio is readjusted according to the voltage level of the driving power to increase the power duration of the battery, whereby power management may be more efficiently managed.

While the present invention has been shown and described in connection with the embodiments, it will be apparent to those skilled in the art that modifications and variations can be made without departing from the spirit and scope of the invention as defined by the appended claims.

What is claimed is:

1. A motor driving apparatus comprising:
a driving power detecting unit detecting a voltage level of driving power used to drive a motor;
a speed controlling unit adjusting a preset duty ratio of a pulse width modulation (PWM) signal when the voltage level detected by the driving power detecting unit is equal to or less than a preset reference voltage;
a driving controlling unit generating a driving signal having the duty ratio from the speed controlling unit; and
a driving unit driving the motor according to the driving signal of the driving controlling unit.

2. The motor driving apparatus of claim 1, wherein the speed controlling unit adjusts a preset on-duty ratio of the PWM signal.

3. The motor driving apparatus of claim 2, wherein the speed controlling unit decreases the preset on-duty ratio of the PWM signal when the voltage level detected by the driving power detecting unit is equal to or less than that of the reference voltage.

4. The motor driving apparatus of claim 1, further comprising a memory storing the duty ratio corresponding to the PWM signal provided from the outside therein.

5. The motor driving apparatus of claim 1, further comprising a speed detecting unit detecting a speed of the motor.

6. The motor driving apparatus of claim 1, wherein the driving power detecting unit includes a comparator comparing the detected voltage level of the driving power and the voltage level of the reference voltage.

7. The motor driving apparatus of claim 6, wherein the comparator performs a hysteresis operation.

8. The motor driving apparatus of claim 7, wherein the reference voltage includes a first reference voltage having a preset voltage level and a second reference voltage having a voltage level set to be higher than the voltage level of the first reference voltage.

9. A motor driving method comprising:
detecting a voltage level of driving power used to drive a motor;
comparing the detected voltage level of the driving power and a voltage level of a preset reference voltage;
adjusting a preset duty ratio of a PWM signal when the detected voltage level of the driving power is equal to or less than that of the reference voltage according to a comparison result; and
driving the motor according to a driving signal having the adjusted duty ratio.

10. The motor driving method of claim 9, wherein in the adjusting of the preset duty ratio, a preset on-duty ratio of the PWM signal is adjusted.

11. The motor driving method of claim 10, wherein in the adjusting of the preset duty ratio, the preset on-duty ratio of the PWM signal is decreased when the detected voltage level of the driving power is equal to or less than that of the reference voltage according to the comparison result.
